(19) United States
(12) Patent Application Publication
(10) Pub. No.: US 2018/0103683 A1
(43) Pub. Date: Apr. 19, 2018

(54) HOOKAH

(71) Applicant: Mike Parker, Woodland Hills, CA (US)

(72) Inventor: Mike Parker, Woodland Hills, CA (US)

(21) Appl. No.: 15/296,409

(22) Filed: Oct. 18, 2016

(51) Int. Cl. A24F 1/30; A24F 7/02; A24F 5/04; F21V 33/00; F21V 3/00; F16K 15/04

(52) U.S. Cl. CPC A24F 1/30; A24F 7/02; A24F 5/04; F21Y 2115/10; F21V 3/00; F16K 15/048; F21V 33/0004

(57) ABSTRACT

A hookah is disclosed including a tobacco bowl in which tobacco is burned and a smoking chamber which is partially filled with water. An air flow tube support is located on top of the smoking chamber and below the tobacco bowl. A plurality of air flow tubes extend downwardly from the tube support and around the smoking chamber below the water therewithin. When a user applies a sucking force to a smoke intake tube that communicates with the interior of the smoking chamber, a mixture of tobacco smoke and air is drawn in to the user's mouth along air flow paths from the tobacco bowl, downwardly through the plurality of air flow tubes and upwardly through the water in the smoking chamber. By virtue of the plurality of air flow tubes, the tobacco smoke will be uniformly distributed within the smoking chamber above the water to improve the taste of the tobacco.

### BACKGROUND OF THE INVENTION

### 1. Field of the Invention

This invention relates to a hookah having a plurality of air flow tubes extending into and spaced from one another around a smoking chamber so that tobacco smoke can be drawn downwardly from a supply of burning tobacco, through the air flow tubes, into water at the bottom of the smoking chamber, and distributed within the smoking chamber above the water by which the flow of air into the chamber is improved and the taste of the tobacco sensed by the smoker is increased. The hookah has components which are magnetically attracted and removably attached to one another to facilitate a quick and easy disassembly.

### 2. Background Art

Hookahs have been long used as devices by which users can smoke tobacco and enjoy the flavor thereof. The traditional hookah has a smoking chamber within which tobacco smoke from burning tobacco is collected and drawn into the mouth of the smoker. A single air flow tube is commonly used to carry a mixture of air and tobacco smoke into the smoking chamber to enable the smoker to taste the tobacco. As a consequence of carrying the air and smoke to the smoking chamber through a single air flow tube, the air supply is both limited and localized within the chamber. Moreover, the tobacco will often burn unevenly such that the tobacco smoke may not be uniformly distributed in the smoking chamber. Consequently, the relatively reduced air flow in traditional hookahs subjects smokers to a correspondingly reduced tobacco taste and enjoyment.

What would therefore be desirable is an improved hookah having a plurality of air flow paths along which the air and tobacco smoke that flow to the smoking chamber can be increased and more uniformly distributed in order to improve the taste of the tobacco sensed by the smoker.

### SUMMARY OF THE INVENTION

In general terms, a hookah is disclosed to enable a user to smoke and enjoy the taste and flavor of tobacco. The hookah has a tobacco bowl in which a supply of tobacco is burnt. The tobacco bowl has a set of air holes formed in the sides and a tobacco juice escape hole formed in the bottom thereof. The tobacco bowl is located above an optically transparent smoking chamber which has an open top through which water is supplied to fill the bottom of the chamber. The top of the smoking chamber is surrounded by an open-ended end cap. A smoke intake hose having a mouthpiece at one end communicates at its opposite end with the smoking chamber through an access hole formed through one side of the end cap. A smoke purge valve communicates with the smoking chamber through an access hole formed through the opposite side of the end cap.

Lying on top of the open-ended end cap of the smoking chamber is a magnetic air flow tube support having a recessed tobacco juice trap in which to collect tobacco juice that drips through the tobacco juice escape hole formed in the bottom of the tobacco bowl. Standing upwardly from the air flow tube support are a plurality of smoke inlets. Coupled to and extending downwardly from respective smoke inlets into and around the smoking chamber are a corresponding plurality of air flow tubes. Seated on and magnetically attached to a base of the magnetic air flow tube support is a tray having an opening that is sized to receive therethrough the upstanding smoke inlets of the tube support. The tobacco bowl is carried by a tobacco bowl pedestal that lays on top of the air flow tube support, such that the air holes formed through the sides of the tobacco bowl lie adjacent the smoke inlets which stand upwardly from the air flow tube support.

Accordingly, when the user exerts a sucking force on the mouthpiece, air flow paths are established to carry a mixture of air and tobacco smoke from the burning tobacco within the tobacco bowl through the smoke inlets of the air flow tube support, downwardly through the plurality of air flow tubes and the water at the bottom of the smoking chamber, and outwardly from the top of the smoking chamber to the user's mouth by way of the smoke intake hose. By virtue of the plurality of air flow tubes and the air flow paths established thereby, the flow of air into the smoking chamber is improved and the tobacco smoke is more uniformly distributed relative to conventional hookahs so as to boost the taste of the tobacco sensed by the user. When the user sucks on the mouthpiece, the ball bearing is positioned to close an air exhaust path through the smoke purge valve and prevent air from being drawn into the smoking chamber from the atmosphere. When the user blows on the mouthpiece, an air exhaust path through the smoke purge valve is opened to enable residual smoke trapped within the smoking chamber to be exhausted into the atmosphere.

The hookah is seated on a magnetic stand which includes a plurality of sections that are magnetically attracted and detachably connected side-by-side one another to create a (e.g., disk-shaped) base. A magnetic seat is located at the center of the base on which the smoking chamber of the hookah is positioned so as to stabilize the hookah and prevent its tilting over during use. An opening is formed through the magnetic seat of the base within which to receive a light emitting diode. When the light emitting diode is energized, rays of light are transmitted upwardly and through the bottom of the smoking chamber to illuminate the water therewithin and thereby provide the user with an aesthetically pleasing visual effect.

### BRIEF DESCRIPTION OF THE DRAWINGS

FIG. 1 is a perspective view showing an improved hookah seated on a magnetic stand according to a preferred embodiment of this invention;

FIG. 2 is an exploded view of the improved hookah and magnetic stand shown in FIG. 1;

FIG. 3 is a cross-section of the improved hookah and magnetic stand taken along lines 3-3 of FIG. 1 to illustrate a plurality of air flow paths that are created through a smoking chamber when a user exerts a sucking force on a mouthpiece of the hookah;

FIGS. 4 and 5 are exploded views showing the smoking chamber of the improved hookah with an air flow tube support and a tray to be located one above the other and seated on top of the smoking chamber;

FIG. 6 is a partially exploded view of the magnetic stand upon which the improved hookah is seated;

FIG. 7 illustrates a modification to the improved hookah shown in FIGS. 1-6 wherein a tobacco bowl of the improved hookah is replaced by an optional adapter having an upstanding hollow stem to be positioned at the top of the smoking chamber;

FIG. 8 shows the optional adapter of FIG. 7 positioned at the top of the smoking chamber and a traditional hookah head seated on the adapter so as to surround and communicate with the upstanding hollow stem thereof; and

FIG. 9 is a cross-section taken along lines 9-9 of FIG. 8 to show the adapter and the top of the smoking chamber at which the adapter is positioned.

### DESCRIPTION OF THE PREFERRED EMBODIMENT

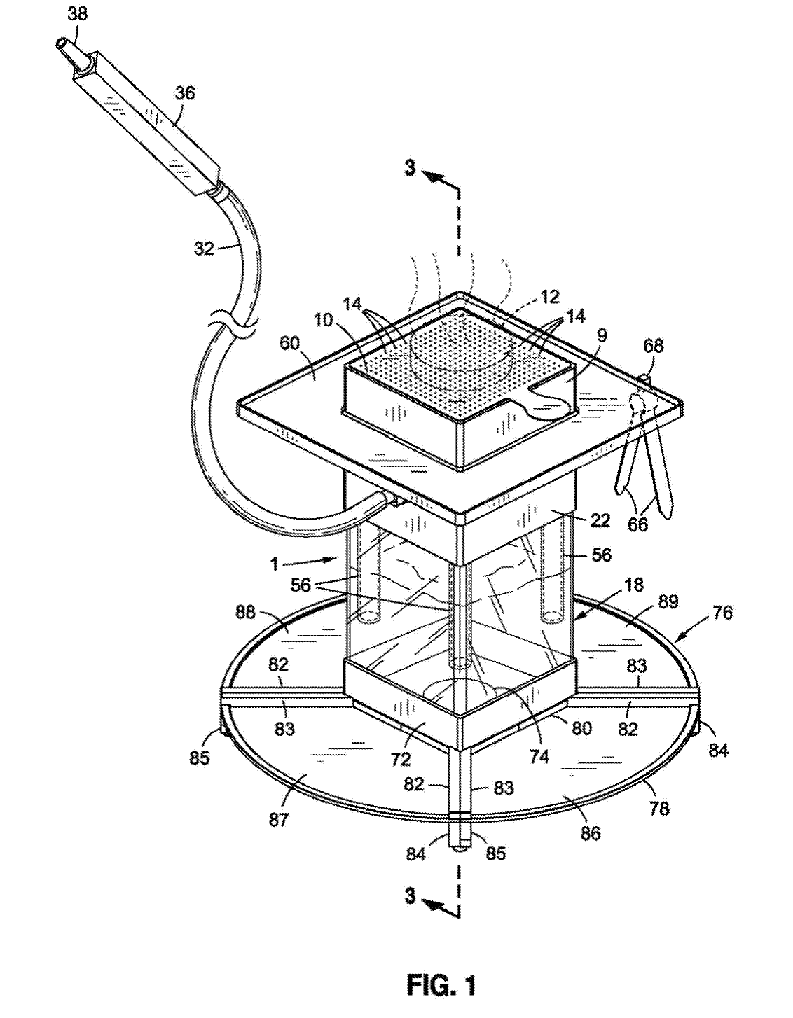

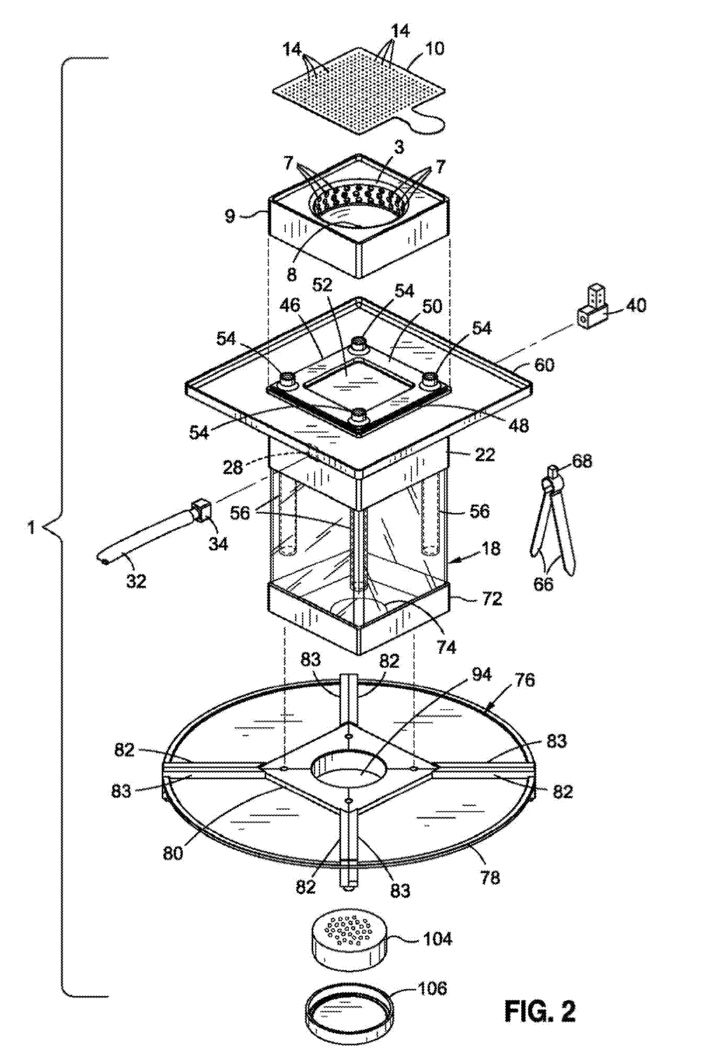

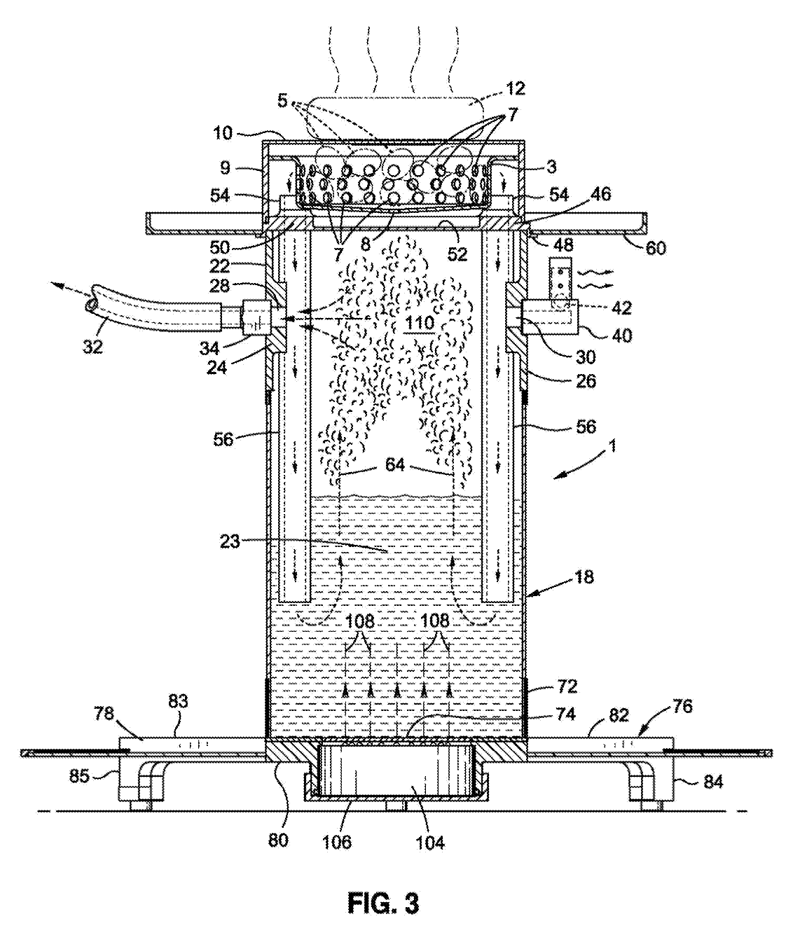

A first embodiment for a hookah is described while referring concurrently to FIGS. 1-6 of the drawings. The hookah 1 enables a user to smoke tobacco or any other suitable combustible plant material. As is best shown in FIGS. 1-3, the hookah 1 includes a tobacco bowl 3 which is preferably filled with a supply of tobacco (designated 5 in FIG. 3) to be smoked by a user. The tobacco bowl 3 has a plurality of air holes 7 formed around the sides to lie in air flow paths along which the smoke generated by the burning tobacco is carried to the user. The tobacco bowl 3 also has a tobacco juice escape hole 8 formed in the bottom thereof (best shown in FIGS. 2 and 3) to permit tobacco juice to drip out of the bowl 3. The tobacco bowl 3 is surrounded and carried by a tobacco bowl pedestal 9.

As is best shown in FIGS. 1 and 2, during use of the hookah 1, a perforated charcoal screen 10 is laid over the top of the tobacco bowl pedestal 9 to cover the tobacco bowl 3 and the tobacco with which the bowl is filled. One or more pieces of charcoal (shown in phantom lines in FIGS. 1 and 3 and designated by the reference numeral 12) are placed on top of the charcoal screen 10 to help burn the tobacco 5. The charcoal screen 10 has a plurality of perforations 14 formed therethrough so that the aforementioned air flow paths will extend through the perforations 14 of the charcoal screen 10, around the charcoal 12 laying on the screen 10, and outwardly from the plurality of air holes 7 of the tobacco bowl 3.

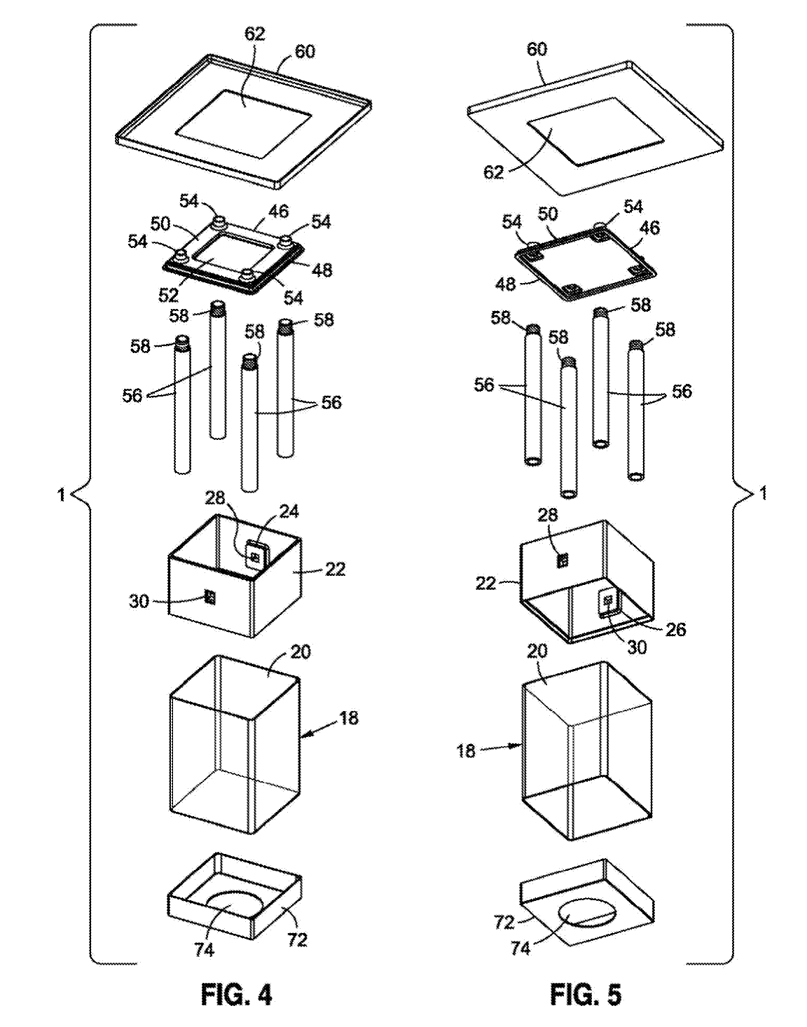

Located below the tobacco bowl 3 and the tobacco 5 placed therein is a hollow smoking chamber 18 that is preferably manufactured from an optically transparent material, such as glass or the like. As is best shown in FIGS. 4 and 5, the smoking chamber 18 has an open top 20 and a closed bottom and sides located in surrounding engagement with the open top 20 of the smoking chamber 18 is a metallic end cap 22. The end cap 22 has an open top, an open bottom and closed sides. In the assembled ready to use hookah configuration shown in FIG. 3, the smoking chamber 18 is partially filled with water 23.

As is best shown in FIGS. 4 and 5, a pair of magnets 24 and 26 are attached to and protrude inwardly towards one another from opposite sides of the end cap 22. The advantage of the magnets 24 and 26 will be explained hereinafter. Access holes 28 and 30 are formed through respective ones of the inwardly protruding magnets 24 and 26. One end of a smoke intake hose 32 communicates with the interior of the smoking chamber 18 by way of a metallic hose adapter 34 that is magnetically attracted by and detachably connected to the magnet 24 at one side of the end cap 22 so as to be held in alignment with the access hole 28. A hand grip 36 (of FIG. 1) is located between the opposite end of the smoke intake hose 32 and a mouthpiece 38 to which a suction force is applied by the mouth of a user.

A metallic smoke purge valve 40 which communicates with the interior of the smoking chamber 18 is magnetically attracted by and detachably connected to the magnet 26 at the opposite side of the end cap 22 so as to be held in alignment with the access hole 30. Because of the symmetry of the smoking chamber 18, the smoke purge valve 40 can be magnetically connected to the magnet 24 at the opposite side of the smoking chamber 18, and the hole adapter 34 can be magnetically connected to magnet 26. As is best shown in FIG. 3, the smoke purge valve 40 carries a ball bearing 42 which is positioned to either open or close an air exhaust path between the interior of the smoking chamber 18 and the atmosphere which surrounds the hookah 1. As will also be explained hereinafter, whether the air exhaust path through the smoke purge valve 40 is opened or closed is dependent upon whether the user applies a sucking or a blowing force to the mouth piece 38 that is attached to the smoke intake hose 32 which communicates with the interior of the smoking chamber 18 via the access hole 28 through end cap 22.

Seated on top of the end cap 22 which is located in surrounding engagement with the top of the smoking chamber 18 is an air flow tube support 46. The air flow tube support 46 includes a rectangular base 48 having a size and shape in order to be able to lie over and cover the open top of the end cap 22 of the smoking chamber 18. The base 48 of the air flow support 46 is magnetic so that the metallic end cap 22 atop the smoking chamber 18 is magnetically attracted by and connected to tube support 46. The air flow tube support 46 can be separated from smoking chamber 18 by applying a pulling force to the tube support 46 to break the magnetic force generated by the base 48 of tube support 46 against end cap 22. A raised lip 50 extends around the periphery of the rectangular base 48 so as to create a recessed trap 52 that is surrounded by the lip 50 within which to collect any tobacco juice that drips down from the supply of tobacco 5 via the escape hole 8 that is formed through the bottom of the tobacco bowl 3.

Standing upwardly from the peripheral lip 50 at the corners of the air flow tube support 46 are a plurality of threaded hollow and cylindrical smoke inlets 54. The smoke inlets 54 extend through the tube support 46 so as to communicate with the smoking chamber 18 above which the tube support 46 is positioned. As is best shown in FIG. 3, the top ends of the plurality of threaded smoke inlets 54 lie adjacent the tobacco bowl 3 so as to communicate with the air holes 7 formed therethrough. A corresponding plurality of cylindrical air flow tubes 56 having threaded tops 58 (best shown in FIGS. 4 and 5) are screwed into removable coupling engagement with respective ones of the threaded smoke inlets 54.

Thus, in the assembled configuration of the hookah 1 shown in FIG. 3 the air flow tubes 56 are coupled to and extend downwardly from respective smoke inlets 54 of the air flow tube support 46 to be located around the smoking chamber 18. Accordingly, and as an important advantage of the hookah 1 herein disclosed relative to conventional hookahs, the aforementioned plurality of air flow tubes 56 can be spaced from one another within the smoking chamber 18 so as to improve air flow through the hookah 1. In this manner, the tobacco smoke that is carried by air flowing into the smoking chamber 18 will be uniformly distributed to provide the user with more flavor and better taste from the tobacco 5 which is burning within the tobacco bowl 3 below which the air flow tubes 56 are disposed.

A rectangular tray 60 of the hookah 1 is located in surrounding engagement with the air flow tube support 46 having the plurality of upstanding smoke inlets 54 to which the corresponding plurality of air flow tubes 56 are coupled. The tray 60 is preferably manufactured from metal to be magnetically attracted by and held against the magnetic base 48 of the air flow tube support 46. Located at the center of the tray 60 is a (e.g., rectangular) opening 62. In the assembled ready-to-use hookah configuration of FIG. 3, the opening 62 is sized and shaped so that the tray 60 lays on the magnetic base 48 of tube support 46 such that the raised peripheral lip 50 of tube support 46 extends upwardly through the opening 62. The tobacco bowl pedestal 9 is seated on top of the air flow tube support 46 so as to surround the raised peripheral lip 50 of the tube support 46 which is received through the opening 62 of tray 60.

The tray 60 lies below the tobacco bowl pedestal 9 and extends laterally outward from the air flow tube support 46 to catch any of the charcoal (designated 5 in FIG. 3) that might fall out of the tobacco bowl 3. The outwardly extending tray 60 also distributes weight around the smoking chamber 18 so as to help the hookah 1 to remain upright during use.

Therefore, the tobacco bowl 3 is held by the tobacco bowl pedestal 9 above the plurality of smoke inlets 54 which stand upwardly from the raised peripheral lip 50 of the air flow tube support 46. Accordingly, when the user applies a sucking force to the mouthpiece 38 of the smoke intake hose 32, air flow paths (designated 64 and shown in broken lines in FIG. 3) are created along which tobacco smoke is mixed with and carried by air outwardly through the air holes 7 formed in the tobacco bowl 3 so as to be uniformly distributed within the smoking chamber 18 by way of the plurality of smoke inlets 54 and the corresponding plurality of air flow tubes 56. When the hookah 1 is to be disassembled for cleaning, shipment and/or storage, the aforementioned tray 60 above which the tobacco bowl pedestal 9 is located is pulled upwardly and separated from the tube support 48 to break the magnetic attraction therebetween.

An optional set of non-metallic tongs 66 is removably attached to the tray 60. Located at the top of the tongs 66 is a magnet 68 by which the tongs are magnetically attracted to and held against the metallic tray 60. The tongs 66 provide the user of the hookah 1 with the ability to move around the charcoal 12 which lies on top of the charcoal screen 10.

The closed bottom of the optically transparent smoking chamber 18 of the hookah 1 is surrounded and engaged by a bottom end cap 72. The end cap 72 is preferably manufactured from a metallic material. The smoking chamber 18 and the end caps 22 and 72 surrounding the top and bottom thereof are assembled as a single unit. A light transmitting window 74 (best shown in FIGS. 4 and 5) is formed through the bottom end cap 72 so that light can be supplied from a source thereof into the interior of the smoking chamber 18 via window 74.

With the end cap 72 attached in surrounding engagement to the bottom of the smoking chamber 18, the smoking chamber can be either laid on a table (not shown) or on an optional magnetic stand 76. The magnetic stand 76 has a (e.g., disk-shaped) base 78 with a magnetic seat 80 located at the center thereof and sized to receive the end cap 72 thereon. The metallic end cap 72 of the smoking chamber is attracted by and detachably connected to the magnetic seat 80 of the stand 76 so as to provide stability and prevent the hookah 1 from leaning to one side and falling over during use. Pairs of side-by-side ribs 82 and 83 which are evenly spaced from one another run radially outwardly along the base 78 from the seat 80. The outer-most ends of the ribs 82 and 83 bend downwardly from the bottom of the base 78 to establish corresponding pairs of side-by-side legs 84 and 85 to support the magnetic stand 76 above a table or other suitable flat surface.

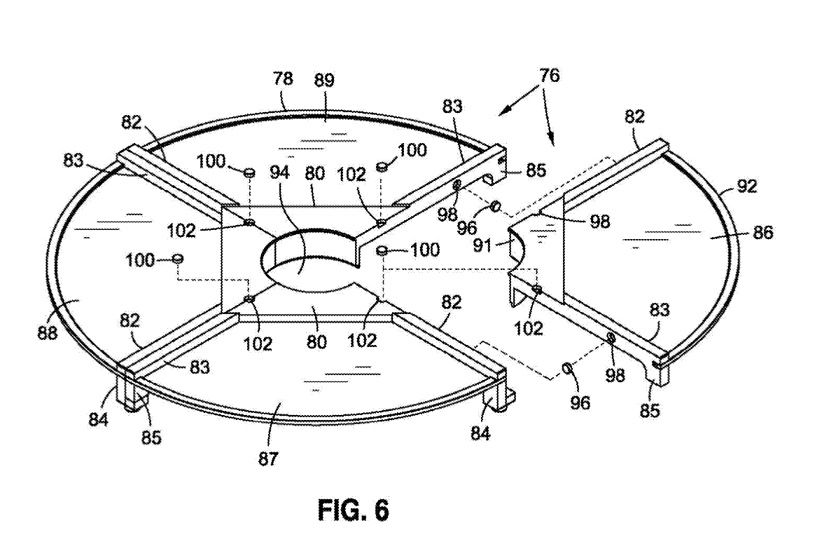

As another important feature of this invention, and referring particularly to FIG. 6 of the drawings, the base 78 of the magnetic stand 76 on which the smoking chamber 18 can be laid includes a plurality of generally triangular sections that are detachably connected to one another. In the example shown, the base 78 is divided into four identical sections 86, 87, 88 and 89 that are preferably manufactured from heat resistant tempered glass. Each section (e.g., 86) of the base 78 has an arc-shaped inner edge 91, an arc-shaped outer edge 92 and a pair of flared sides which extend between the inner and outer arc-shaped edges 91 and 92. When the base sections 86-89 are joined side-by-side one another as shown in FIG. 2, the respective arc-shaped inner edges 91 thereof are aligned to establish a cylindrical light source receiving opening 94 through the seat 80 at the center of the base 78.

A first rib 82 and a second rib 83 are attached to each section 86-89 of the base 78. The first rib 82 having a first magnetic polarity runs along one of the pairs of sides of each base section 86-89 between the inner and outer arc-shaped edges 91 and 92 thereof, and a second rib 83 having an opposite magnetic polarity runs along the other side. Therefore, when the base sections 86-89 are assembled side-by-side one another, a rib 82 from one section (e.g., 86) having the first magnetic polarity is aligned side-by-side a rib 83 from an adjacent section (e.g., 89) having the opposite magnetic polarity. In this manner, the sections 86-89 are magnetically attracted and detachably connected one to the other to assemble the (disk-shaped) base 78 of the magnetic stand 76. When it is desirable to disassemble the stand 76 for packaging, shipment and/or storage, a pulling force is applied to the base sections 86-89 that is sufficient to overcome the magnetic attraction therebetween, whereby the sections can be separated from one another.

A first set of alignment pegs 96 are pushed into receipt by opposing cavities 98 that are formed in each of the pair of side-by-side aligned ribs 82 and 83 from respective ones of the side-by-side aligned sections 86-89 of the base 78 of the magnetic stand 76. A second set of alignment pegs 100 are pushed into receipt by respective cavities 102 that are formed in the seat 80 at the center of the base 78 so as to lie between adjacent pairs of the base sections 86-89. The sets of alignment pegs 96 and 100 reinforce the connection of the base sections 86-89 side-by-side one another so that the (disk-shaped) base 78 of the magnetic stand 76 can be assembled and made ready for use.

In the assembled ready to use hookah configuration shown in FIG. 3, with the smoking chamber 18 being held atop the magnetic seat 80 of the magnetic stand 76, the light source receiving opening 94 that is formed through the seat 80 of the base 78 is positioned below and axially aligned with the light transmitting window 74 that is formed in the end cap 72 that lies in surrounding engagement with the bottom of smoking chamber 18. As is best shown in FIG. 2, a light source such as, for example, a conventional cylindrical and waterproof light emitting diode (LED) 104 is located within the cylindrical light source receiving opening 94 of seat 80. An optional remote control (not shown) can be used to adjust the intensity of the light generated by the LED 104. A cover 106 is placed over the LED 104 to avoid damage that might be caused by any water leaks from the smoking chamber 18 and prevent the LED from falling out of the light source receiving opening 94 in the seat 80 of the base 78 of stand 76.

When the optically transparent smoking chamber 18 is laying on the seat 80 of the base of stand 76 and the LED 104 is energized, rays of light (designated 108 and shown as broken lines in FIG. 3) are transmitted through the light transmitting window 74 formed in the end cap 72 that surrounds the bottom of the smoking chamber 18 and into the water 23 with which the bottom of chamber 18 is filled to provide the user with an aesthetically pleasing visual effect.

Use of the hookah 1 is now described while continuing to refer to FIGS. 1-6. With the tobacco 5 burning in the tobacco bowl 3, the user applies a suction force to the mouthpiece 38 of the smoke intake hose 32. The suction force draws tobacco smoke outwardly from the tobacco bowl 3, through the water 23 within the smoking chamber 18 to cool the smoke and remove tobacco residue therefrom, and into the user's mouth via the access hole 28 formed in the magnet 24 of end cap 22 and the smoke intake hose 32. More particularly, the tobacco smoke is mixed with air and suctioned along the air flow paths 64 of FIG. 3, through the air holes 7 in the tobacco bowl 3, downwardly through the plurality of air flow tubes 56 that are spaced from one another around the smoking chamber 18, upwardly through the water 23 to be uniformly distributed throughout the smoking chamber 18 above the water (designated 110 in FIG. 3), and outwardly through smoke intake hose 32. The suction force created by the user also pulls the ball bearing 42 within the smoke purge valve 40 to a position at which to close an air exhaust path from the outside atmosphere to the smoking chamber 18 by way of the access hole 30 that runs through the magnet 26 of end cap 22 and communicates with the smoking chamber.

During those times when the user is not smoking the tobacco 5, he may apply a blowing force into the smoking chamber 18 by way of the mouthpiece 38 and the smoke intake hose 32. In this case, the ball bearing 42 is pushed upwardly and repositioned within the smoke purge valve 40 as shown in FIG. 3 so as to open the air exhaust path to the atmosphere to permit the user to exhaust residual smoke from the smoking chamber 18 via the access hole 30 through the magnet 26 of end cap 22.

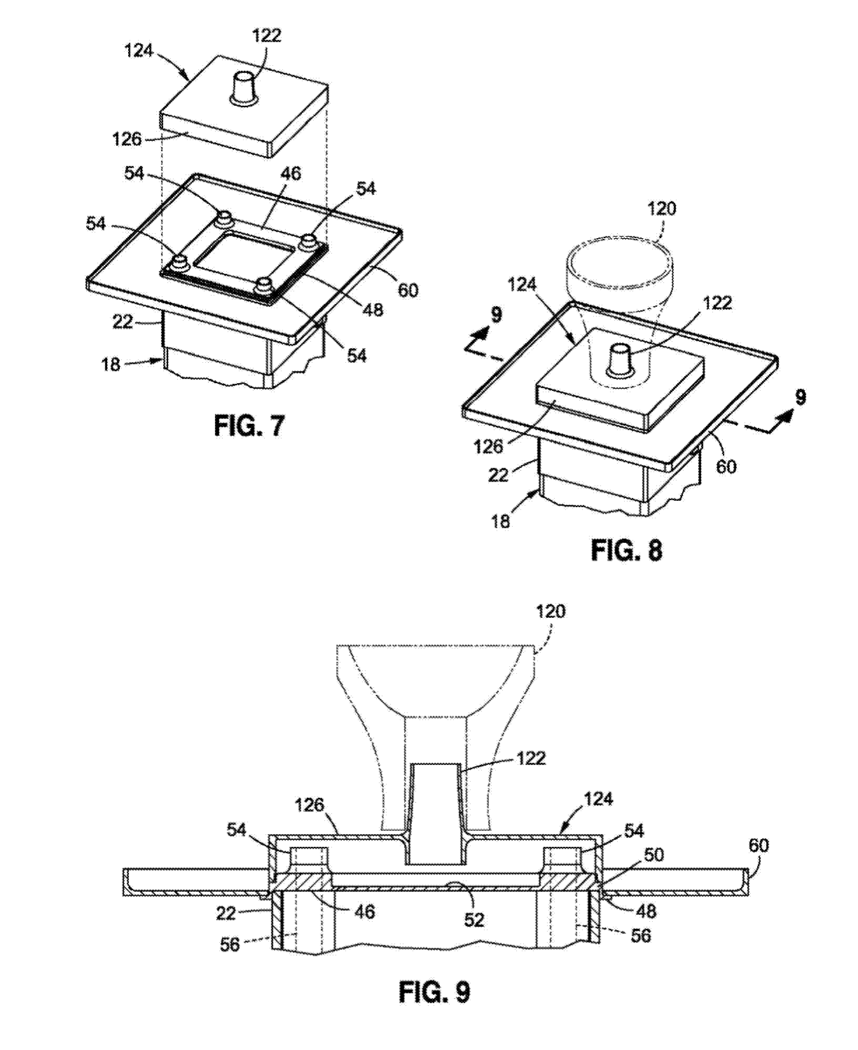

Turning now to FIGS. 7-9 of the drawings, a modified hookah embodiment is shown which uses a conventional hookah head 120 in place of the tobacco bowl (designated 3 in FIGS. 1-3) that is used by the improved hookah 1. Identical reference numerals are used to describe identical features of the hookah 1 of FIGS. 1-6 and the modified hookah embodiment of FIGS. 7-9.

The same smoking chamber 18 from the hookah 1 that was described while referring to FIGS. 1-6 and within which a plurality of air flow tubes 56 are located communicates with a hollow stem 122 of an optional metallic adapter 124. The adapter 124 has a rectangular body 126 that is sized and shaped to lay on the air flow tube support 46 that extends across the end cap 22 at the top of the smoking chamber 18. In particular, the rectangular body 126 of the adapter 124 is seated on the raised peripheral lip 50 of the air flow tube support 46. The hollow stem 122 stands upwardly from and extends through the body 126 of adapter 124 so as to lie above the threaded smoke inlets 54 of the air flow tube support 46. The flat metallic tray 60 above which the adapter 124 is located is seated on the magnetic base 48 of the tube support 46. Therefore, both the tray 60 and the adapter 124 are magnetically attracted by the magnetic base 48 and held in place against the air flow tube support 46.

In the hookah embodiment shown in FIGS. 7-9, the hookah head 120 is laid on top of the adapter 124 so as to surround the upstanding stem 122 which runs through the adapter body 126. Thus, continuous air flow paths are created along which tobacco smoke is carried from the stem 122, downwardly through the plurality of air flow tubes 56 via the smoke inlets 54, and into the water 23 (of FIG. 3) within the smoking chamber 18. The hookah head 120 is filled with a supply of tobacco (not shown), and the tobacco is ignited to generate the tobacco smoke. Tobacco juice will drip from the supply of tobacco within the hookah head 120 to be captured by the tobacco juice trap 52 that is surrounded by the raised peripheral lip 50 of the air flow tube support 46.

The user applies a suction force to the mouthpiece 38 of the smoke intake hose 32 (of FIG. 3), whereby tobacco smoke (designated 110 in FIG. 3) that is collected within the smoking chamber 18 is drawn into the mouth of the user along the aforementioned air flow paths. Accordingly, the user receives the benefit of having a mixture of air and tobacco smoke travel downwardly through the plurality of air flow tubes 56 so that the air flow to the smoking chamber 18 is increased and the tobacco smoke is uniformly distributed therewithin to improve the flavor and the taste of the tobacco sensed by the user in the same manner as was previously described with regard to the hookah 1 shown in FIGS. 1-6.

1. A hookah, comprising:
a tobacco container in which to receive a supply of tobacco to be burned to create tobacco smoke, said tobacco container having at least one opening formed therethrough;
a smoking chamber having an interior at which tobacco smoke is collected;
a plurality of air flow tubes having first ends lying adjacent said tobacco container and opposite ends extending into the interior at said smoking chamber; and
a smoke intake hose having a first end at which to receive a suction force applied thereto from the mouth of a smoker and an opposite end communicating with the interior of said smoking chamber, such that a plurality of air flow paths are created by which tobacco smoke is mixed with air and drawn from said tobacco container into the mouth of the smoker by way of the at least one opening formed through said tobacco container, said plurality of air flow tubes extending into the interior of said smoking chamber, and said smoke intake hose communicating with said interior.

2. The hookah recited in claim 1, wherein said plurality of air flow tubes are distributed around the interior of said smoking chamber.

3. The hookah recited in claim 1, wherein said smoking chamber has at least first and second sides, said hookah further comprising a first magnet located within the first side of said smoking chamber and having an access hole formed therethrough which communicates with the interior of said smoking chamber, said smoke intake hose having a metallic hose adapter located at the opposite end thereof and being magnetically and detachably connected to said first magnet, such that the opposite end of said smoke intake hose communicates with the interior of said smoking chamber by way of the access hole formed through said first magnet.

4. The hookah recited in claim 3, further comprising a second magnet located within the second side of said smoking chamber and having an access hole formed therethrough which communicates with the interior of said smoking chamber, and a metallic smoke purge valve magnetically and detachably connected to said second magnet and communicating with the atmosphere surrounding said smoking chamber, said smoke purge valve being responsive to a blowing force applied from the mouth of the smoker to the interior of said smoking chamber by way of said smoke intake hose so that an air exhaust path is opened through said smoke purge valve by which tobacco smoke trapped within the interior of said smoking chamber is exhausted to the atmosphere by way of the access hole formed through said second magnet.

5. The hookah recited in claim 1, wherein said smoking chamber has a top and a bottom, said hookah further comprising an air flow tube support located at the top of said smoking chamber, said plurality of air flow tubes connected at the first ends thereof to said air flow tube support and extending downwardly from said air flow tube support so that the opposite ends of said plurality of air flow tubes are located within and distributed around the interior of said smoking chamber.

6. The hookah recited in claim 5, wherein said tobacco container has at least one tobacco juice escape hole formed therein and said air flow tube support has a tobacco juice trap located below the tobacco juice escape hole of said tobacco container so as to collect tobacco juice which leaks outwardly from the tobacco container via said escape hole formed therein.

7. The hookah recited in claim 5, wherein said air flow tube support is manufactured from a magnetic material.

8. The hookah recited in claim 7, further comprising a flat metallic plate lying below and extending outwardly relative to said tobacco chamber, said flat metallic plate having an opening through which to receive and surround said magnetic air flow tube support, such that said flat metallic plate is magnetically attracted by said magnetic air flow tube support.

9. The hookah recited in claim 5, wherein said air flow tube support includes a plurality of hollow smoke inlets which run therethrough and communicate with the at least one opening formed through said tobacco container so as to lie in said plurality of air flow paths, said plurality of air flow tubes detachably connected at the first ends thereof to respective ones of said plurality of smoke inlets of said air flow tube support.

10. The hookah recited in claim 9, further comprising an adapter seated on said air flow tube support above said plurality of smoke inlets thereof, said adapter having a hollow stem standing upwardly and positioned so that said plurality of smoke inlets communicate with the at least one opening formed through said tobacco container by way of the upstanding hollow stem of said adapter.

11. The hookah recited in claim 9, wherein said tobacco container is a tobacco bowl, said hookah further comprising a tobacco bowl pedestal surrounding said tobacco bowl, said pedestal seated on said air flow tube support so that the at least one opening formed through said tobacco bowl is positioned above and in communication with the plurality of smoke inlets of said air flow tube support.

12. A combination, comprising:
a hookah including:
a tobacco container in which to receive a supply of tobacco to be burned to create tobacco smoke, said tobacco container having at least one opening formed therethrough;
a smoking chamber having a top and a bottom and an interior at which tobacco smoke is collected;
a plurality of air flow tubes having first ends lying adjacent said tobacco container and opposite ends extending into the interior at said smoking chamber; and
a smoke intake hose having a first end at which to receive a suction force applied thereto from the mouth of a smoker and an opposite end communicating with the interior of said smoking chamber, such that a plurality of air flow paths are created by which tobacco smoke is mixed with air and drawn from said tobacco container into the mouth of the smoker by way of the at least one opening formed through said tobacco container, said plurality of air flow tubes extending into the interior of said smoking chamber, and said smoke intake hose communicating with said interior; and
a stand on which said hookah is seated, said stand including a plurality of sections that are detachably connected side-by-side one another.

13. The combination recited in claim 12, wherein the plurality of sections of said stand are magnetically attracted so as to be held side-by-side one another.

14. The combination recited in claim 13, wherein each section of said plurality of sections of said stand has first and opposite sides that have opposite magnetic polarities relative to one another.

15. The combination recited in claim 14, wherein the first side of each section of said stand includes a metallic rib having the first magnetic polarity, and the opposite side of each section of said stand includes a metallic rib having the opposite magnetic polarity.

16. The combination recited in claim 12, wherein said stand includes a seat upon which said hookah is seated, said seat having a light source receiving opening formed therein and lying below the smoking chamber of said hookah.

17. The combination recited in claim 16, wherein the smoking chamber of said hookah is optically transparent, said combination further comprising a light source located within the light source receiving opening formed in the seat of said stand, said light source being energized to emit rays of light into the interior of said optically transparent smoking chamber.

18. The combination recited in claim 16, wherein the seat of said stand is manufactured from a magnetic material and wherein the smoking chamber of said hookah has a metallic end cap attached to the bottom thereof, said metallic end cap being magnetically attracted by said magnetic seat to hold said smoking chamber on said stand.
